(19) United States
(12) Patent Application Publication
(10) Pub. No.: US 2006/0294560 A1
(43) Pub. Date: Dec. 28, 2006

(54) Cable broadcasting system, cable broadcasting transmitting apparatus, cable broadcasting receiver, open cable broadcasting receiver and cable card

(75) Inventors: Do-young Kim, Suwon-si (KR); Eun-kyung Kang, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/384,307

(22) Filed: Mar. 21, 2006

(30) Foreign Application Priority Data
Jun. 28, 2005 (KR) 10-2005-0056624

(51) Int. Cl. H04N 7/173; H04N 7/16

(52) U.S. Cl. 725/100; 725/131; 725/139; 725/117; 725/147

(57) ABSTRACT

A cable broadcasting system is provided which includes a cable broadcasting transmitting apparatus and a cable broadcasting receiving apparatus which are connected to a cable network. The cable broadcasting transmitting apparatus includes a broadcasting signal generator, a sensitivity adjusting signal generator which generates a sensitivity adjusting control signal and a transmitter which transmits a cable broadcasting signal and the sensitivity adjusting control signal. The cable broadcasting receiving apparatus includes a sensitivity adjuster which receives the cable broadcasting signal a controller which controls the sensitivity adjuster to adjust sensitivity of the cable broadcasting signal. Thus, a cable broadcasting system, a cable broadcasting transmitting apparatus, a cable broadcasting receiver, an Open Cable broadcasting receiver and a cable card are provided which allow remote adjustment of the sensitivity of a cable broadcasting signal which is supplied to a cable broadcasting receiving apparatus.

### CROSS-REFERENCE TO RELATED APPLICATIONS

This application claims priority from Korean Patent Application No. 10-2005-0056624, filed on Jun. 28, 2005 in the Korean Intellectual Property Office, the entire disclosure of which is incorporated herein by reference.

### BACKGROUND OF THE INVENTION

1. Field of the Invention

Apparatuses consistent with the present invention relate to a cable broadcasting system, a cable broadcasting transmitting apparatus, a cable broadcasting receiver, an Open Cable broadcasting receiver and a cable card, and more particularly, to adjusting sensitivity of a cable broadcasting signal that is supplied to a receiver according to a sensitivity adjusting control signal of a cable broadcasting transmitting apparatus.

2. Description of the Related Art

Generally, a cable broadcasting system comprises a cable broadcasting transmitting apparatus that transmits a cable broadcasting signal through a cable network; and a cable broadcasting receiving apparatus that receives a cable broadcasting signal from the cable network.

The cable broadcasting transmitting apparatus uses an inherent identification (ID) of the cable broadcasting receiving apparatus to transmit predetermined information or control signals to the cable broadcasting receiving apparatus.

Meanwhile, as the cable broadcasting signal is supplied to the cable broadcasting receiving apparatus from the cable broadcasting transmitting apparatus in a remote distance, the cable broadcasting signal may be degraded while being transmitted through a long cable line. If the cable broadcasting signal is degraded, the cable broadcasting receiving apparatus may not display the cable broadcasting properly. Therefore, a cable broadcasting operator may be required to amplify sensitivity of the cable broadcasting signal.

If the sensitivity of the cable broadcasting signal is amplified, cable broadcasting receiving apparatuses of respective houses may receive the cable broadcasting signals in different sensitivity. Thus, individually adjusting the sensitivity of the cable broadcasting signal supplied to the cable broadcasting receiving apparatus may be required.

Particularly, it would be preferable if sensitivity of the cable broadcasting signal supplied to the cable broadcasting receiving apparatus according to the control signal of the cable broadcasting transmitting apparatus remote from the cable broadcasting receiving apparatus, is adjusted in real-time without requiring a service call at a user's location to adjust the user's receiving apparatus.

### SUMMARY OF THE INVENTION

The present invention provides a cable broadcasting system, a cable broadcasting transmitting apparatus, a cable broadcasting receiver, an Open Cable broadcasting receiver and a cable card which allow sensitivity adjustment of a cable broadcasting signal which is supplied to a cable broadcasting receiving apparatus from a remote distance.

According to an exemplary embodiment of the present invention, there is provided a cable broadcasting system comprising a cable broadcasting transmitting apparatus and a cable broadcasting receiving apparatus which is connected to the cable broadcast transmitting apparatus via a cable network, wherein the cable broadcasting transmitting apparatus comprises a broadcasting signal generator which generates a cable broadcasting signal, a sensitivity adjusting signal generator to generate a sensitivity adjusting control signal and a transmitter which transmits the cable broadcasting signal and the sensitivity adjusting control signal to the cable broadcasting receiving apparatus, and wherein the cable broadcasting receiving apparatus comprises a sensitivity adjuster which receives the cable broadcasting signal from the cable broadcasting transmitting apparatus and outputs the cable broadcasting signal at a sensitivity which is adjusted, and a controller which controls the sensitivity adjuster to adjust the sensitivity of the cable broadcasting signal which is output by the sensitivity adjuster based on the sensitivity adjusting control signal which is received from the cable broadcasting transmitting apparatus.

According to an exemplary embodiment of the present invention, the cable broadcasting receiving apparatus further comprises a signal sensitivity detector which detects the sensitivity of the cable broadcasting signal, which is output by the sensitivity adjuster, and the controller transmits signal sensitivity information, which indicates the sensitivity of the cable broadcasting signal detected by the signal detector, to the cable broadcasting transmitting apparatus, and the cable broadcasting transmitting apparatus further comprises a receiver, and the sensitivity adjusting signal generator transmits the sensitivity adjusting control signal to adjust the sensitivity of the cable broadcasting signal which is output by the sensitivity adjuster based on the signal sensitivity information which is received by the receiver of the cable broadcasting transmitting apparatus.

According to another exemplary embodiment of the present invention, the signal sensitivity information may comprise an inherent identification of the cable broadcasting receiver.

According to another exemplary embodiment of the present invention, the cable broadcasting receiving apparatus further comprises a set top box which includes a tuner which selects the cable broadcasting signal output by the sensitivity adjuster, a demodulator which demodulates the cable broadcasting signal selected by the tuner, the signal sensitivity detector, the controller and an out of band (OOB) processor which communicates bidirectionally with the cable broadcasting transmitting apparatus, and the signal sensitivity detector detects the sensitivity of the cable broadcasting signal which is demodulated by the demodulator, and the controller transmits the signal sensitivity information, which indicates the sensitivity of the cable broadcasting signal detected by the signal sensitivity detector, to the cable broadcasting transmitting apparatus, by use of the OOB processor.

According to another embodiment of the present invention, the cable broadcasting receiving apparatus further comprises an Open Cable set top box which operates according to an Open Cable protocol, the Open Cable set top box including a tuner which selects the cable broadcasting signal output by the sensitivity adjuster, a demodulator which demodulates the cable broadcasting signal selected by the tuner, the signal sensitivity detector, a host processor which transmits a detection result of the signal sensitivity detector in response to a predetermined request signal, and an out of band (OOB) transceiver which communicates bidirectionally with the cable broadcasting transmitting apparatus, and a cable card which includes the controller and communicates bidirectionally with the Open Cable set top box through a point of deployment (POD) interface.

According to another exemplary embodiment of the present invention, the controller requests the host processor to transmit the detection result, which is received by the host processor from the signal sensitivity detector, and the controller transmits the signal sensitivity information based on the detection result from the signal sensitivity detector, which is transmitted from the host processor in response to the request by the controller, to the cable broadcasting transmitting apparatus, by use of the OOB transmitter/receiver.

According to another exemplary embodiment of the present invention, the controller repeatedly requests host processor to transmit the detection result of the signal sensitivity detector at predetermined intervals.

According to another exemplary embodiment of the present invention, the controller requests the host processor to transmit the detection result if the cable broadcasting transmitting apparatus requests the detection result of the signal sensitivity detector.

According to an exemplary embodiment of the present invention, there is provided a cable broadcasting transmitting apparatus which is connected with a cable broadcasting receiving apparatus including a sensitivity adjuster, the cable broadcasting transmitting apparatus comprising a broadcasting signal generator which generates a cable broadcasting signal; a sensitivity adjusting signal generator which generates a sensitivity adjusting control signal to adjust sensitivity of the cable broadcasting signal which is output by the sensitivity adjuster of the broadcast receiving apparatus; and a transmitter which transmits the cable broadcasting signal and the sensitivity adjusting control signal.

According to another exemplary embodiment of the present invention, the apparatus further comprises a receiver which receives signal sensitivity information which indicates the sensitivity of the cable broadcasting signal that is output by the sensitivity adjuster, wherein the sensitivity adjusting signal generator generates the sensitivity adjusting control signal based on the signal sensitivity information which is received if the sensitivity adjusting signal generator receives the signal sensitivity information from the cable broadcasting receiving apparatus by use of the receiver.

According to an exemplary embodiment of the present invention, there is provided a cable broadcasting receiver which receives a cable broadcasting signal from a cable broadcasting transmitting apparatus, the cable broadcasting receiver comprising a sensitivity adjuster which receives the cable broadcasting signal from the cable broadcasting transmitting apparatus and outputs the cable broadcasting signal at a sensitivity which is adjusted; a signal processor which communicates bidirectionally with the cable broadcasting transmitting apparatus; and a controller which controls the sensitivity adjuster to adjust the sensitivity of the cable broadcasting signal output by the sensitivity adjuster based on the sensitivity adjusting control signal which is received from the cable broadcasting transmitting apparatus if the controller receives a sensitivity adjusting control signal from the cable broadcasting transmitting apparatus by use of the signal processor.

According to another exemplary embodiment of the present invention, the cable broadcasting receiver further comprises a tuner which selects the cable broadcasting signal received from the sensitivity adjuster, a demodulator which demodulates the cable broadcasting signal selected by the tuner and a signal sensitivity detector which detects the sensitivity of the cable broadcasting signal demodulated by the demodulator, wherein the controller transmits signal sensitivity information which indicates the sensitivity of the cable broadcasting signal, which is detected by the signal sensitivity detector, to the cable broadcasting transmitting apparatus, by use of the signal processor.

According to another exemplary embodiment of the present invention, the signal sensitivity information comprises an inherent identification of the cable broadcasting receiver.

According to an exemplary embodiment of the present invention, there is provided an Open Cable broadcasting receiver which satisfies an Open Cable protocol and receives a cable broadcasting signal output from a cable broadcasting transmitting apparatus, the Open Cable broadcasting receiver comprising a sensitivity adjuster which receives the cable broadcasting signal from the cable broadcasting transmitting apparatus and outputs the cable broadcasting signal at a sensitivity which is adjusted; an out of band (OOB) transceiver which communicates bidirectionally with the cable broadcasting transmitting apparatus; a signal sensitivity detector which detects the sensitivity of the cable broadcasting signal which is output by the sensitivity adjuster; and a host processor which transmits a detection result of the signal sensitivity detector by a resource which transmits the detection result of the signal detector in a resource layer of a point of deployment (POD) interface protocol.

According to an exemplary embodiment of the present invention, there is provided a cable card which satisfies an Open Cable protocol and is connected with an Open Cable broadcasting receiver to receive a cable broadcasting signal which is output from a cable broadcasting transmitting apparatus through a sensitivity adjuster, the cable card comprising an out of band (OOB) protocol processor which receives a predetermined sensitivity adjusting control signal from the cable broadcasting transmitting apparatus; and a controller which controls the sensitivity adjuster to adjust a sensitivity of the cable broadcasting signal which is output by the sensitivity adjuster if the controller receives the sensitivity adjusting control signal.

According to another embodiment of the present invention, the controller comprises a resource which receives a sensitivity detection result of the cable broadcasting signal which is supplied to the Open Cable broadcasting receiver in a resource layer of a point of deployment (POD) interface protocol.

According to another exemplary embodiment of the present invention, the controller transmits signal sensitivity information, which indicates the sensitivity of the cable broadcasting signal which is received, if the controller receives the sensitivity detection result of the cable broadcasting signal.

According to another exemplary embodiment of the present invention, the signal sensitivity information comprises an inherent identification.

According to an exemplary embodiment of the present invention, there is provided a receiver which receives a broadcasting signal from a transmitting apparatus, the receiver comprising a sensitivity adjuster which receives the broadcasting signal from the transmitting apparatus and outputs the broadcasting signal at a sensitivity which is adjusted; and a controller which controls the sensitivity adjuster to adjust the sensitivity of the broadcasting signal output by the sensitivity adjuster based on a sensitivity adjusting control signal which is received from the transmitting apparatus, wherein the receiver is remotely located with respect to the transmitting apparatus and the receiver and the transmitting apparatus are connected via a communications network.

According to an exemplary embodiment of the present invention, the receiver may further comprise a tuner which selects the broadcasting signal received from the sensitivity adjuster, a demodulator which demodulates the broadcasting signal selected by the tuner and a signal sensitivity detector which detects the sensitivity of the broadcasting signal demodulated by the demodulator, wherein the controller transmits signal sensitivity information which indicates the sensitivity of the broadcasting signal, which is detected by the signal sensitivity detector, to the broadcasting transmitting apparatus, by use of the signal processor.

### BRIEF DESCRIPTION OF THE DRAWINGS

The above and other aspects of the present invention will become apparent and more readily appreciated from the following description of the exemplary embodiments, taken in conjunction with the accompanying drawings of which:

FIG. 1 is a control block diagram of a cable broadcasting system according to a first exemplary embodiment of the present invention;

FIG. 2 is a control block diagram of a cable broadcasting receiving apparatus of a cable broadcasting system according to a second exemplary embodiment of the present invention;

FIG. 3 is a control block diagram of a cable broadcasting receiving apparatus of a cable broadcasting system according to a third exemplary embodiment of the present invention;

FIG. 4 illustrates an example of an object which is required to determine sensitivity of a received cable broadcasting signal; and

FIG. 5 is a control flowchart of the cable broadcasting system according to the third exemplary embodiment of the present invention.

### DETAILED DESCRIPTION OF THE EXEMPLARY EMBODIMENTS OF THE PRESENT INVENTION

Reference will now be made in detail to the exemplary embodiments of the present invention, examples of which are illustrated in the accompanying drawings, wherein like reference numerals refer to like elements throughout.

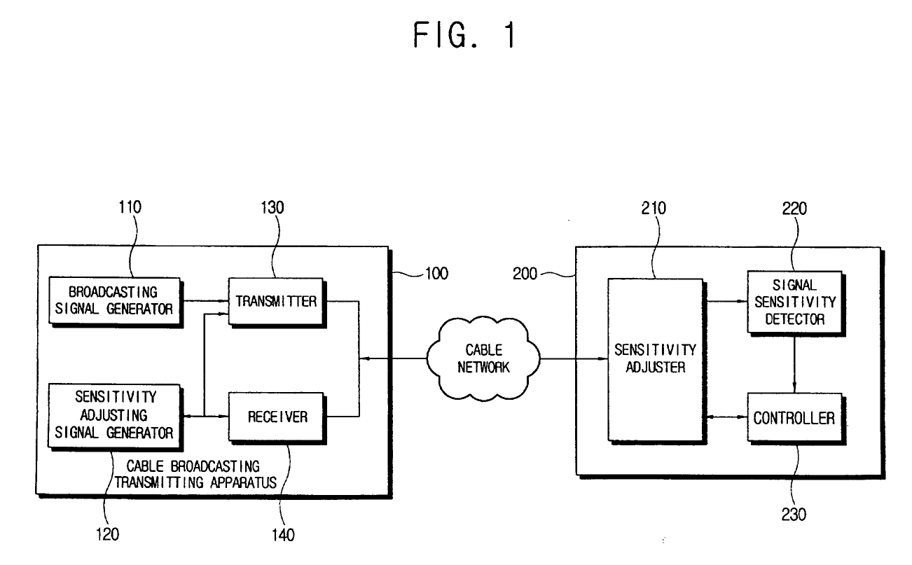

As shown in FIG. 1, a cable broadcasting system according to a first exemplary embodiment of the present invention comprises a cable broadcasting transmitting apparatus 100 to transmit a cable broadcasting signal; and a cable broadcasting receiving apparatus 200 to receive the cable broadcasting signal that is transmitted from the cable broadcasting transmitting apparatus 100. Here, the cable broadcasting comprises the entire broadcastings including cable TV and cable community antenna TV, in which a broadcasting transmitting terminal and a broadcasting receiving terminal are connected with each other through a predetermined network.

The cable broadcasting transmitting apparatus 100 comprises a broadcasting signal generator 110, a sensitivity adjusting signal generator 120, a transmitter 130 and a receiver 140.

The broadcasting signal generator 110 generates a cable broadcasting signal to be displayed on the cable broadcasting receiving apparatus 200. The cable broadcasting signal may be transmitted in an analog or a digital format.

The sensitivity adjusting signal generator 120 generates a sensitivity adjusting control signal to adjust the sensitivity of the cable broadcasting signal output from a sensitivity adjustor 210 of the cable broadcasting receiving apparatus 200 (to be described later).

The transmitter 130 transmits the cable broadcasting signal generated by the broadcasting signal generator 110 and the sensitivity adjusting control signal generated by the sensitivity adjusting signal generator 120 to the cable broadcasting receiving apparatus 200 through a cable network.

The receiver 140 receives signal sensitivity information from the cable broadcasting receiving apparatus 200 (to be described later) to transmit the signal sensitivity information to the sensitivity adjusting signal generator 120.

Meanwhile, the cable broadcasting receiving apparatus 200 comprises the sensitivity adjuster 210, a signal sensitivity detector 220 and a controller 230.

Here, the sensitivity adjuster 210 receives the cable broadcasting signal from the cable broadcasting transmitting apparatus 100 to provide output of the received broadcasting signal. At this time, the sensitivity adjuster 210 may adjust the sensitivity of the cable broadcasting signal by a predetermined external control signal to output the received broadcasting signal at the adjusted sensitivity.

The signal sensitivity detector 220 detects sensitivity of the cable broadcasting signal output by the sensitivity adjuster 210.

The controller 230 controls the sensitivity adjuster 210 to adjust sensitivity of the cable broadcasting signal output by the sensitivity adjuster 210 according to the sensitivity adjusting control signal that is received from the cable broadcasting transmitting apparatus 100. Also, the controller 230 transmits signal sensitivity information, which indicates the sensitivity of the cable broadcasting signal detected by the signal sensitivity detector 220, to the cable broadcasting transmitting apparatus 100.

Then, the sensitivity adjusting signal generator 120 of the cable broadcasting transmitting apparatus 100 may transmit the sensitivity adjusting control signal to adjust the sensitivity of the cable broadcasting signal output by the sensitivity adjuster 210 according to the signal sensitivity information that is received through the receiver 140 from the cable broadcasting receiving apparatus 200.

For example, the cable broadcasting transmitting apparatus 100 may transmit the sensitivity adjusting control signal to amplify the cable broadcasting signal if sensitivity of the cable broadcasting signal output by the sensitivity adjuster 210 is low. The cable broadcasting transmitting apparatus 100 may transmit the sensitivity adjusting control signal irrespective of whether the signal sensitivity information is received from the cable broadcasting receiver 200. The controller 230 of the cable broadcasting receiver 200 may control the sensitivity adjuster 210 according to the received signal sensitivity information.

Thus, the cable broadcasting transmitting apparatus 100 may adjust sensitivity of the cable broadcasting signal output by the sensitivity adjuster 210 of the cable broadcasting receiver 200, in real time from a remote location.

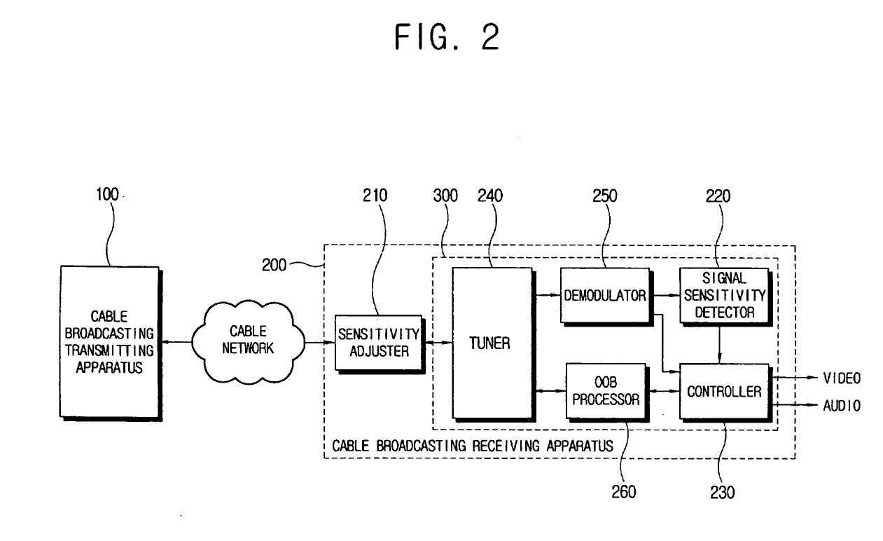

As shown in FIG. 2, a cable broadcasting receiver 200 of a cable broadcasting system according to a second exemplary embodiment of the present invention comprises a sensitivity adjuster 210 and a cable broadcasting receiving part 300.

Here, the sensitivity adjuster 210 amplifies a cable broadcasting signal that is received from a cable broadcasting transmitting apparatus 100 to output the cable broadcasting signal to the cable broadcasting receiver 300. The sensitivity adjuster 210 may be provided as a booster amplifier.

The cable broadcasting receiver 300 may comprise a set top box or a TV which receives signals output from the sensitivity adjuster 210 to convert them into images.

Hereinafter, the cable broadcasting receiver 300 is provided as the set top box according to an exemplary embodiment of the present invention.

The set top box 300 comprises a tuner 240, a demodulator 250, a signal sensitivity detector 220, a signal processor 260 and a controller 230.

The tuner 240 is provided to select a cable broadcasting signal that is received from the sensitivity adjuster 210. The demodulator 250 demodulates the cable broadcasting signal selected by the tuner 240. If the cable broadcasting is provided as a digital broadcasting, the demodulator 250 may perform a quadrature amplitude modulation (QAM) to demodulate the cable broadcasting signal.

The signal sensitivity detector 220 detects sensitivity of the cable broadcasting signal that is output by the demodulator 250. Sensitivity of the cable broadcasting signal detected by the signal sensitivity detector 220 serves as a basis of a sensitivity adjusting control signal supplied by the cable broadcasting transmitting apparatus 100. The signal sensitivity detector 220 will be described in detail together with the controller 230.

The signal processor 260 transmits and receives various control signals of a digital cable broadcasting, such as signal sensitivity information and the sensitivity adjusting control signal. The signal processor 260 is provided for two-way communication of the cable broadcasting transmitting apparatus 100 and the set top box 300. Hereinafter, the signal processor 260 is provided as an out of band (OOB) processor according to an exemplary embodiment of the present invention.

The controller 230 transmits the signal sensitivity information on sensitivity of the cable broadcasting signal detected by the signal sensitivity detector 220 to the cable broadcasting transmitting apparatus 100 through the OOB processor 260. Also, the controller 230 controls the sensitivity adjuster 210 based on the received sensitivity adjusting control signal if the controller 230 receives the sensitivity adjusting control signal according to the signal sensitivity information from the cable broadcasting transmitting apparatus 100.

For example, if the sensitivity of the cable broadcasting signal supplied to the set top box 300 is low, the signal sensitivity information according to a detection result of the signal sensitivity detector 220 is transmitted to the cable broadcasting transmitting apparatus 100 by the controller 230. The cable broadcasting transmitting apparatus 100 transmits the sensitivity adjusting control signal to allow the signal sensitivity detector 220 to amplify sensitivity of the cable broadcasting signal into a certain degree. Then, the controller 230 which has received the sensitivity adjusting control signal, controls the sensitivity adjuster 210 to amplify sensitivity of the received cable broadcasting signal to a specified sensitivity level.

Meanwhile, the controller 230 may control the sensitivity adjuster 210 through the OOB processor 260 and the tuner 240, or through other configurations. The sensitivity adjuster 210 may further comprise a reception port to be controlled by the controller 230.

The tuner 240, the demodulator 250 and the signal sensitivity detector 220 of the set top box 300 are illustrated as being separate elements in FIG. 2 to describe functions thereof. However, the tuner 240, the demodulator 250 and the signal sensitivity detector 220 may be integrated into a single chip which comprises functions of the three elements.

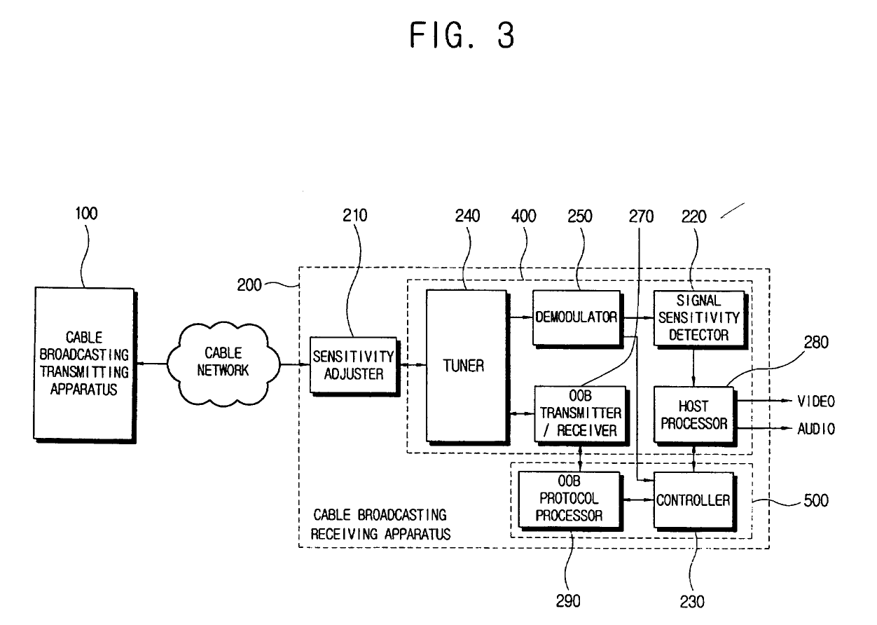

As shown in FIG. 3, a cable broadcasting receiving apparatus 200 of a cable broadcasting system according to a third exemplary embodiment of the present invention comprises a sensitivity adjuster 210, an Open Cable set top box 400 and a cable card 500.

The Open Cable set top box 400 as an Open Cable broadcasting receiver corresponds to an Open Cable protocol. The Open Cable set top box 400 may comprise a tuner 240, a demodulator 250, a signal sensitivity detector 220, an OOB transmitter/receiver 270 and a host processor 280.

The tuner 240, the demodulator 250 and the signal sensitivity detector 220 according to the third exemplary embodiment of the present invention correspond to those elements as described in the second exemplary embodiment of the present invention.

The OOB transmitter/receiver 270 performs two-way communication according to the Open Cable protocol. The OOB transmitter/receiver 270 transmits a control signal supplied by the cable broadcasting transmitting apparatus 100 to the cable card 500 (to be described later) and conversely transmits the control signal supplied by the cable card 500 to the cable broadcasting transmitting apparatus 100.

The host processor 280 transmits a detection result of the signal sensitivity detector 220 about the cable broadcasting signal to the cable card 500 (to be described later).

Meanwhile, the cable card 500 may comprise an OOB protocol processor 290 to perform two-way communication with the OOB transmitter/receiver 270, and a controller 230.

The controller 230 transmits signal sensitivity information according to the detection result of the signal sensitivity detector 220 about the cable broadcasting signal supplied by the host processor 280 to the cable broadcasting transmitting apparatus 100 through the OOB protocol processor 290 and the OOB transmitter/receiver 270 of the Open Cable set top box 400.

At this time, the controller 230 may repeatedly request the detection result of the signal sensitivity detector 220 to the host processor 280 at predetermined intervals. If the cable broadcasting transmitting apparatus 100 requests the detection result of the signal sensitivity detector 220, the controller 230 may request the detection result of the signal sensitivity detector 220 to the host processor 280.

The controller 230 controls the sensitivity adjuster 210 based on the received sensitivity adjusting control signal if the controller 230 receives the sensitivity adjusting control signal according to the signal sensitivity information from the cable broadcasting transmitting apparatus 100.

Then, sensitivity of the cable broadcasting signal may be adjusted, which is supplied to the Open Cable set top box 400 according to the sensitivity adjusting control signal of the cable broadcasting transmitting apparatus 100, which is based on sensitivity of the received cable broadcasting signal.

Meanwhile, a resource layer of a point of deployment (POD) interface protocol may comprise a resource to allow information such as the detection result of the signal detector to be exchanged between the Open Cable set top box 400 and the cable card 500 if they abide by the Open Cable protocol.

Thus, the resource which determines sensitivity of the received cable broadcasting signal is added to the resource layer of the POD interface protocol. Also, objects of the added resource are defined to allow the set top box 300 and the cable card 500 to exchange data each other.

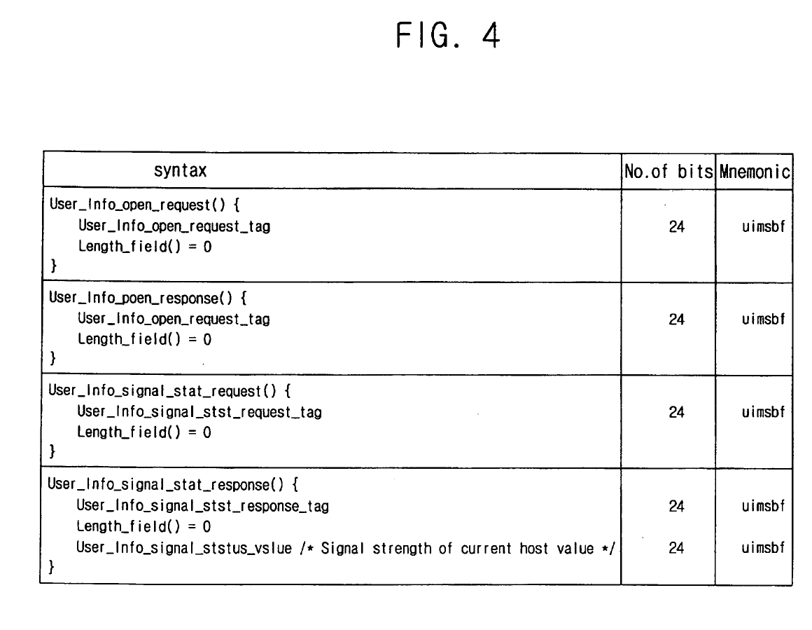

FIG. 4 illustrates an example of the object required to determine sensitivity of the received cable broadcasting signal.

Here, User_Info_open_request ( ) is an object which performs an initialization function for a communication between the cable card 500 and the Open Cable set top box 400, and is transmitted from the cable card 500 to the Open Cable set top box 400.

User_Info_open_response ( ) is an object by which the Open Cable set top box 400 responds to an initialization request of the cable card 500.

User_Info_signal_stat_request ( ) is an object by which the cable card 500 requests the detection result of the received cable broadcasting signal to the set top box 400.

User_Info_signal_stat_response ( ) is an object by which the Open Cable set top box 400 transmits the detection result of the received cable broadcasting signal to the cable card 500 corresponding to the request of the cable card 500.

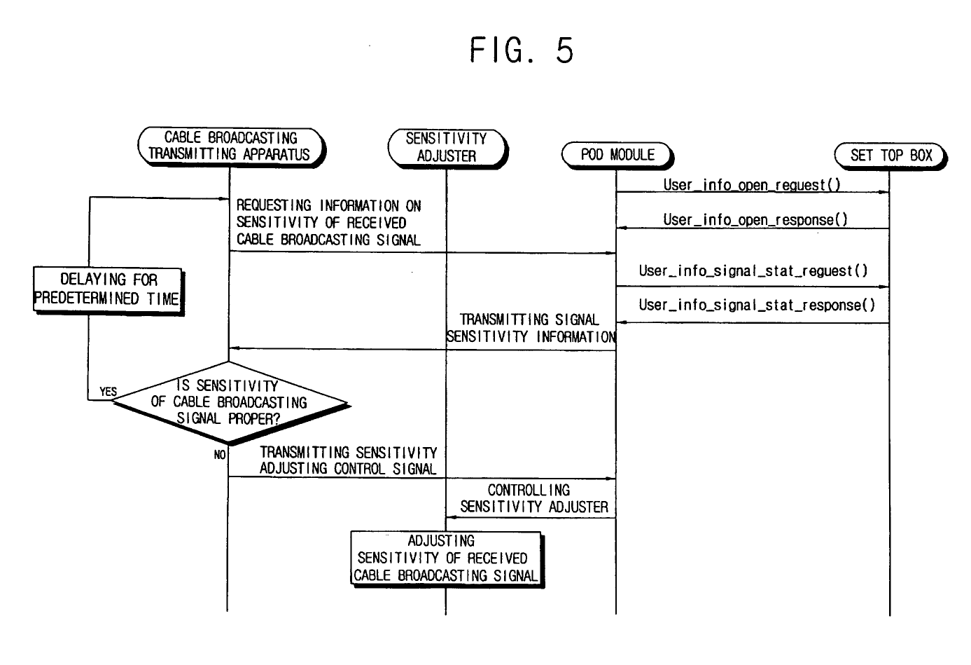

Referring to FIG. 5, a control flow of the cable broadcasting system according to the third exemplary embodiment of the present invention will be described.

If power is initially supplied or an initialization is required, the cable card 500 transmits the User_Info_open_request ( ) object to the Open Cable set top box 400 for the initialization operation. The Open Cable set top box 400 which has received the User_Info_open request ( ) responds through the User_Info_open_response ( ).

The set top box 300 and/or the cable card 500 are assigned an inherent ID by the User_Info_open_request ( ) and User_Info_open_response ( ) objects, and the inherent ID may be stored in the cable card 500.

The cable broadcasting transmitting apparatus 100 requests information on the sensitivity of the cable broadcasting signal supplied to the Open Cable set top box 400, to the cable card 500. Then, the cable card 500 transmits the User_Info_signal_stat_request ( ) object to the Open Cable set top box 400 to request the sensitivity detection result of the cable broadcasting signal. The Open Cable set top box 400 transmits the sensitivity detection result of the cable broadcasting signal to the cable card 500 corresponding to the request of the cable card 500, through the User_Info_signal_stat_response ( ) object.

The cable card 500 transmits the signal sensitivity information according to the sensitivity detection result of the cable broadcasting signal supplied by the Open Cable set top box 400, to the cable broadcasting transmitting apparatus 100.

At this time, the signal sensitivity information may comprise an ID to be assigned to the cable card 500 and/or the Open Cable set top box 400.

The cable broadcasting transmitting apparatus 100 which has received the signal sensitivity information determines whether sensitivity of the cable broadcasting signal supplied to the cable broadcasting receiving apparatus 200 is proper, and transmits the sensitivity adjusting control signal to adjust sensitivity if the cable broadcasting transmitting apparatus 100 determines that the sensitivity is not proper.

The cable card 500 which has received the sensitivity adjusting control signal controls the sensitivity adjuster 210 to adjust sensitivity of the received cable broadcasting signal.

Then, the cable broadcasting transmitting apparatus 100 may determine and adjust sensitivity of the cable broadcasting signal supplied to the cable broadcasting receiving apparatus 200, in real-time. Particularly, the ID of the cable card 500 and/or the Open Cable set top box 400 may be used to adjust sensitivity of the cable broadcasting signal by the respective cable broadcasting receiving apparatuses.

In the foregoing exemplary embodiments, the set top box or the Open Cable set top box may comprise various broadcasting receivers that may be integrally provided in a TV. The function of controlling the sensitivity adjuster according to the sensitivity adjusting control signal of the cable broadcasting transmitting apparatus may be included in the sensitivity adjuster itself as well as in the controller of the set top box or the cable card.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A cable broadcasting system comprising:
a cable broadcasting transmitting apparatus; and
a cable broadcasting receiving apparatus which is connected to the cable broadcast transmitting apparatus via a cable network,
wherein the cable broadcasting transmitting apparatus comprises a broadcasting signal generator which generates a cable broadcasting signal, a sensitivity adjusting signal generator which generates a sensitivity adjusting control signal, and a transmitter which transmits the cable broadcasting signal and the sensitivity adjusting control signal to the cable broadcasting receiving apparatus, and
wherein the cable broadcasting receiving apparatus comprises a sensitivity adjuster which receives the cable broadcasting signal from the cable broadcasting transmitting apparatus and outputs the cable broadcasting signal at a sensitivity which is adjusted, and a controller which controls the sensitivity adjuster to adjust the sensitivity of the cable broadcasting signal which is output by the sensitivity adjuster based on the sensitivity adjusting control signal which is received from the cable broadcasting transmitting apparatus.

2. The cable broadcasting system according to claim 1, wherein the cable broadcasting receiving apparatus further comprises a signal sensitivity detector which detects the sensitivity of the cable broadcasting signal output by the sensitivity adjuster, and the controller transmits signal sensitivity information, which indicates the sensitivity of the cable broadcasting signal detected by the signal detector, to the cable broadcasting transmitting apparatus,
wherein the cable broadcasting transmitting apparatus further comprises a receiver, and the sensitivity adjusting signal generator transmits the sensitivity adjusting control signal to adjust the sensitivity of the cable broadcasting signal which is output by the sensitivity adjuster based on the signal sensitivity information which is received from the cable broadcasting receiving apparatus by the receiver of the cable broadcasting transmitting apparatus.

3. The cable broadcasting system according to claim 2, wherein the signal sensitivity information comprises an inherent identification of the cable broadcasting receiver.

4. The cable broadcasting system according to claim 3, wherein the cable broadcasting receiving apparatus further comprises a set top box which includes a tuner which selects the cable broadcasting signal, which is output by the sensitivity adjuster, a demodulator which demodulates the cable broadcasting signal selected by the tuner, the signal sensitivity detector, the controller and an out of band (OOB) processor which communicates bidirectionally with the cable broadcasting transmitting apparatus, and the signal sensitivity detector detects the sensitivity of the cable broadcasting signal which is demodulated by the demodulator, and the controller transmits the signal sensitivity information, which indicates the sensitivity of the cable broadcasting signal detected by the signal sensitivity detector, to the cable broadcasting transmitting apparatus by use of the OOB processor.

5. The cable broadcasting system according to claim 3, wherein the cable broadcasting receiving apparatus further comprises an Open Cable set top box which operates according to an Open Cable protocol, the Open Cable set top box including a tuner which selects the cable broadcasting signal output by the sensitivity adjuster, a demodulator which demodulates the cable broadcasting signal selected by the tuner, the signal sensitivity detector, a host processor which transmits a detection result from the signal sensitivity detector in response to a predetermined request signal, and an out of band (OOB) transceiver which communicates bidirectionally with the cable broadcasting transmitting apparatus, and a cable card which includes the controller and communicates bidirectionally with the Open Cable set top box through a point of deployment (POD) interface.

6. The cable broadcasting system according to claim 5, wherein the controller requests the host processor to transmit the detection result, which is received by the host processor from the signal sensitivity detector, and the controller transmits the signal sensitivity information based on the detection result from the signal sensitivity detector, which is transmitted from the host processor in response to the request by the controller, to the cable broadcasting transmitting apparatus by use of the OOB transceiver.

7. The cable broadcasting system according to claim 6, wherein the controller repeatedly requests the host processor to transmit the detection result of the signal sensitivity detector at predetermined intervals.

8. The cable broadcasting system according to claim 7, wherein the controller requests the host processor to transmit the detection result if the cable broadcasting transmitting apparatus requests the detection result of the signal sensitivity detector.

9. A cable broadcasting transmitting apparatus which is connected with a cable broadcasting receiving apparatus including a sensitivity adjuster, the cable broadcasting transmitting apparatus comprising:
a broadcasting signal generator which generates a cable broadcasting signal;
a sensitivity adjusting signal generator which generates a sensitivity adjusting control signal to adjust sensitivity of the cable broadcasting signal which is output by the sensitivity adjuster of the broadcast receiving apparatus; and
a transmitter which transmits the cable broadcasting signal and the sensitivity adjusting control signal.

10. The cable broadcasting transmitting apparatus according to claim 9, further comprising a receiver which receives signal sensitivity information which indicates the sensitivity of the cable broadcasting signal that is output by the sensitivity adjuster,
wherein the sensitivity adjusting signal generator generates the sensitivity adjusting control signal based on the signal sensitivity information which is received if the sensitivity adjusting signal generator receives the signal sensitivity information from the cable broadcasting receiving apparatus by use of the receiver.

11. A cable broadcasting receiver which receives a cable broadcasting signal from a cable broadcasting transmitting apparatus, the cable broadcasting receiver comprising:
a sensitivity adjuster which receives the cable broadcasting signal from the cable broadcasting transmitting apparatus and outputs the cable broadcasting signal at a sensitivity which is adjusted;
a signal processor which communicates bidirectionally with the cable broadcasting transmitting apparatus; and
a controller which controls the sensitivity adjuster to adjust the sensitivity of the cable broadcasting signal output by the sensitivity adjuster based on the sensitivity adjusting control signal which is received from the cable broadcasting transmitting apparatus if the controller receives a sensitivity adjusting control signal from the cable broadcasting transmitting apparatus by use of the signal processor.

12. The cable broadcasting receiver according to claim 11, further comprising a tuner which selects the cable broadcasting signal received from the sensitivity adjuster, a demodulator which demodulates the cable broadcasting signal selected by the tuner and a signal sensitivity detector which detects the sensitivity of the cable broadcasting signal demodulated by the demodulator,
wherein the controller transmits signal sensitivity information which indicates the sensitivity of the cable broadcasting signal, which is detected by the signal sensitivity detector, to the cable broadcasting transmitting apparatus, by use of the signal processor.

13. The cable broadcasting receiver according to claim 12, wherein the signal sensitivity information comprises an inherent identification of the cable broadcasting receiver.

14. An Open Cable broadcasting receiver which satisfies an Open Cable protocol and receives a cable broadcasting signal output from a cable broadcasting transmitting apparatus, the Open Cable broadcasting receiver comprising:
a sensitivity adjuster which receives the cable broadcasting signal from the cable broadcasting transmitting apparatus and outputs the cable broadcasting signal at a sensitivity which is adjusted;
an out of band (OOB) transceiver which communicates bidirectionally with the cable broadcasting transmitting apparatus;
a signal sensitivity detector which detects the sensitivity of the cable broadcasting signal which is output by the sensitivity adjuster; and
a host processor which transmits a detection result of the signal sensitivity detector by a resource which transmits the detection result of the signal detector in a resource layer of a point of deployment (POD) interface protocol.

15. A cable card which satisfies an Open Cable protocol and is connected with an Open Cable broadcasting receiver to receive a cable broadcasting signal which is output from a cable broadcasting transmitting apparatus through a sensitivity adjuster, the cable card comprising:
an out of band (OOB) protocol processor which receives a predetermined sensitivity adjusting control signal from the cable broadcasting transmitting apparatus; and
a controller which controls the sensitivity adjuster to adjust a sensitivity of the cable broadcasting signal which is output by the sensitivity adjuster if the controller receives the sensitivity adjusting control signal.

16. The cable card according to claim 15, wherein the controller comprises a resource which receives a sensitivity detection result of the cable broadcasting signal which is supplied to the Open Cable broadcasting receiver in a resource layer of a point of deployment (POD) interface protocol.

17. The cable card according to claim 16, wherein the controller transmits signal sensitivity information, which indicates the sensitivity of the cable broadcasting signal which is received, if the controller receives the sensitivity detection result of the cable broadcasting signal.

18. The cable card according to claim 17, wherein the signal sensitivity information comprises an inherent identification.

19. A receiver which receives a broadcasting signal from a transmitting apparatus, the receiver comprising:
a sensitivity adjuster which receives the broadcasting signal from the transmitting apparatus and outputs the broadcasting signal at a sensitivity which is adjusted; and
a controller which controls the sensitivity adjuster to adjust the sensitivity of the broadcasting signal output by the sensitivity adjuster based on a sensitivity adjusting control signal which is received from the transmitting apparatus,
wherein the receiver is remotely located with respect to the transmitting apparatus and the receiver and the transmitting apparatus are connected via a communications network.

20. The receiver according to claim 19, further comprising a tuner which selects the broadcasting signal received from the sensitivity adjuster, a demodulator which demodulates the broadcasting signal selected by the tuner and a signal sensitivity detector which detects the sensitivity of the broadcasting signal demodulated by the demodulator,
wherein the controller transmits signal sensitivity information which indicates the sensitivity of the broadcasting signal, which is detected by the signal sensitivity detector, to the broadcasting transmitting apparatus, by use of the signal processor.
